(19) United States
(12) Patent Application Publication
(10) Pub. No.: US 2018/0274464 A1
(43) Pub. Date: Sep. 27, 2018

(54) MOTOR VEHICLE INCLUDING A LEAN NOX TRAP REGENERATION SYSTEM AND METHOD FOR REGENERATION

(71) Applicant: GM GLOBAL TECHNOLOGY OPERATIONS LLC, Detroit, MI (US)

(72) Inventors: Stefano Pellegrino, Troy, MI (US); Charles E. Solbrig, Ypsilanti, MI (US); Jean-Yves Lavallee, Farmington Hills, MI (US)

(21) Appl. No.: 15/470,618

(22) Filed: Mar. 27, 2017

(51) Int. Cl. F02D 41/02; F01N 3/08; F01N 3/20; F01N 13/00

(52) U.S. Cl. CPC F02D 41/0275; F01N 3/0814; F01N 3/0871; F02D 2250/18; F01N 3/2066; F01N 13/009; F02D 41/027; F01N 3/0885

(57) ABSTRACT

An emissions control system for a motor vehicle including an internal combustion engine includes a lean NOx trap (LNT) device including an LNT inlet and an LNT outlet, and a LNT sensor arranged at the LNT inlet. The LNT sensor is operable to detect a temperature of exhaust gases passing into the LNT device. A selective catalytic reduction (SCR) member is fluidically connected to the LNT device. The SCR device includes an SCR inlet and an SCR outlet. An SCR sensor is mounted to the SCR. The SCR sensor is operable to detect a temperature of the SCR. A LNT regeneration control system including a LNT regeneration controller is operatively connected to the LNT sensor and the SCR sensor. The LNT regeneration control system is operable to activate the LNT regeneration controller based on inputs from the LNT sensor and the SCR sensor.

### INTRODUCTION

The subject disclosure relates to the art of motor vehicles and, more particularly, to a lean NOx trap (LNT) regeneration system and method or regenerating a LNT.

Motor vehicles include various systems for reducing regulated exhaust constituents such as CO, NOx, and the like. One system, typically employed in diesel engine systems is a NOx absorber or Lean NOx trap (LNT). A NOx absorber typically employs an adsorbent, such as barium, that traps NO and NO₂ molecules present in engine exhaust. Over time, the adsorbent may become saturated and further adsorption may be hindered. There exist a number of procedures for regenerating or desorbing NO and NO₂ molecules from the adsorbent. The procedures are typically triggered when certain operating conditions of the LNT and the motor vehicle are met.

In most cases, a De-NOx event or regeneration is triggered based on engine working point parameters, such as engine speed and load, and LNT parameters such as LNT inlet temperature and NOx storage capability. Once a De-NOx event is activated, NO and NO₂ molecules are released into the engine exhaust. The released NO and NO₂ molecules react with hydrocarbons/CO/H₂ to produce water and nitrogen. However, under certain conditions, CO₂ may also be produced. Accordingly, it is desirable to provide a system for regenerating a LNT while lowering undesirable constituents, such as CO₂.

### SUMMARY

In accordance with an exemplary embodiment, an emissions control system for a motor vehicle including an internal combustion engine includes a lean NOx trap (LNT) device including an LNT inlet and an LNT outlet, and a LNT sensor arranged at the LNT inlet. The LNT sensor is operable to detect a temperature of exhaust gases passing into the LNT device. A selective catalytic reduction (SCR) member is fluidically connected to the LNT device. The SCR device includes an SCR inlet and an SCR outlet. An SCR sensor is mounted to the SCR. The SCR sensor is operable to detect a temperature of the SCR. A LNT regeneration control system including a LNT regeneration controller is operatively connected to the LNT sensor and the SCR sensor. The LNT regeneration control system is operable to activate the LNT regeneration controller based on inputs from the LNT sensor and the SCR sensor.

In addition to one or more of the features described above or below, or as an alternative, further embodiments could include wherein the SCR includes an SCR substrate, the SCR sensor being operatively coupled to the SCR substrate.

In addition to one or more of the features described above or below, or as an alternative, further embodiments could include an engine load sensor operable to detect a load of the internal combustion engine, and a speed sensor operable to detect a speed of the internal combustion engine. The LNT regeneration control system is operable to activate the LNT regeneration control based on inputs from at least one of the engine load sensor and the speed sensor.

In addition to one or more of the features described above or below, or as an alternative, further embodiments could include wherein the LNT regeneration control system includes at least one memory module having stored thereon a SCR temperature threshold value, the LNT regeneration control system being operable to activate the LNT regeneration controller when the temperature of the SCR is below the SCR temperature threshold value.

In addition to one or more of the features described above or below, or as an alternative, further embodiments could include wherein the SCR inlet is fluidically connected to the LNT outlet.

In accordance with another aspect of an exemplary embodiment, a motor vehicle includes an internal combustion engine having an exhaust system, and an emissions control system fluidically connected to the exhaust system. The emissions control system includes a lean NOx trap (LNT) device having an LNT inlet and an LNT outlet. A LNT sensor is arranged at the LNT inlet. The LNT sensor is operable to detect a temperature of exhaust gases passing into the LNT device. A selective catalytic reduction (SCR) member is fluidically connected to the LNT device. The SCR device includes an SCR inlet and an SCR outlet. An SCR sensor is mounted to the SCR. The SCR sensor is operable to detect a temperature of the SCR. A LNT regeneration control system including a LNT regeneration controller is operatively connected to the LNT sensor and the SCR sensor. The LNT regeneration control system is operable to activate the LNT regeneration controller based on inputs from the LNT sensor and the SCR sensor.

In addition to one or more of the features described above or below, or as an alternative, further embodiments could include wherein the SCR includes an SCR substrate, the SCR sensor being operatively coupled to the SCR substrate.

In addition to one or more of the features described above or below, or as an alternative, further embodiments could include an engine load sensor operable to detect a load of the internal combustion engine, and a speed sensor operable to detect a speed of the internal combustion engine. The LNT regeneration control system is operable to activate the LNT regeneration control based on inputs from at least one of the engine load sensor and the speed sensor.

In addition to one or more of the features described above or below, or as an alternative, further embodiments could include wherein the LNT regeneration control system includes at least one memory module having stored thereon a SCR temperature threshold value, the LNT regeneration control system being operable to activate the LNT regeneration controller when the temperature of the SCR device is below the SCR temperature threshold value.

In addition to one or more of the features described above or below, or as an alternative, further embodiments could include wherein the SCR inlet is fluidically connected to the LNT outlet.

In accordance with yet another aspect of an exemplary embodiment, a method of regenerating a lean NOx trap (LNT) device of an internal combustion engine in a motor vehicle includes sensing a temperature of an SCR device fluidically connected to the LNT, sensing a temperature of the LNT device, and activating a regeneration controller to de-adsorb NOx from the LNT device based on the temperature of the SCR device and the temperature of the LNT.

In addition to one or more of the features described above or below, or as an alternative, further embodiments could include wherein sensing the temperature of the SCR device includes sensing the temperature of an SCR substrate of the SCR device.

In addition to one or more of the features described above or below, or as an alternative, further embodiments could include wherein sensing the temperature of the LNT device includes sensing a temperature of an LNT inlet of the LNT device.

In addition to one or more of the features described above or below, or as an alternative, further embodiments could include sensing a load on the internal combustion engine, and sensing a speed of the internal combustion engine, wherein the regeneration controller is activated based on at least one of the load of the internal combustion engine and the speed of the internal combustion engine.

In addition to one or more of the features described above or below, or as an alternative, further embodiments could include wherein the regeneration controller is activated when the temperature of the SCR device is below a predetermined temperature threshold.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a motor vehicle including an internal combustion engine and an emission control system having a lean NOx trap (LNT) device regeneration system, in accordance with an aspect of an exemplary embodiment;

FIG. 2 is a block diagram depicting the emission control system, in accordance with an aspect of an aspect of exemplary embodiment;

FIG. 3 is a block diagram depicting the LNT regeneration control system, in accordance with an aspect of an exemplary embodiment; and

FIG. 4 is a flow chart depicting a method of regenerating a LNT device, in accordance with an aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory module that executes one or more software or firmware programs, a combinational logic circuit, and/or other suitable components that provide the described functionality.

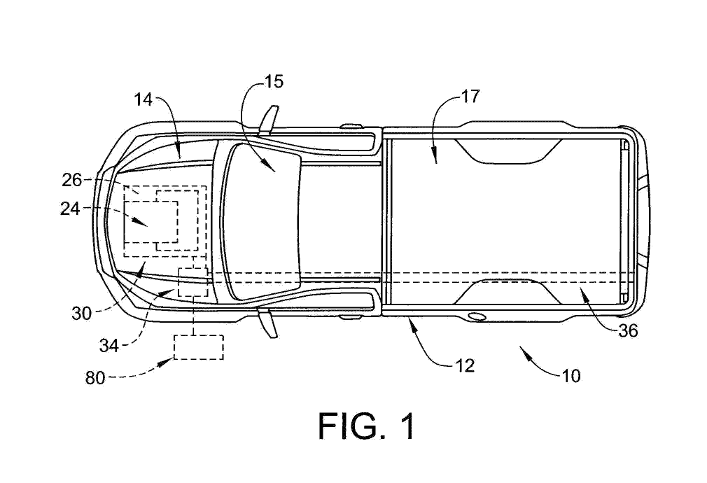

A motor vehicle, in accordance with an aspect of an exemplary embodiment, is indicated generally at 10 in FIG. 1. Motor vehicle 10 is shown in the form of a pickup truck. It is to be understood that motor vehicle 10 may take on various forms including automobiles, commercial transports, marine vehicles, and the like. Motor vehicle 10 includes a body 12 having an engine compartment 14, a passenger compartment 15, and a cargo bed 17. Engine compartment 14 houses an internal combustion engine system 24 which, in the exemplary embodiment shown, may include a diesel engine 26. Internal combustion engine system 24 includes an exhaust system 30 that is fluidically connected to an aftertreatment or emissions control system 34. Exhaust produced by internal combustion engine system 24 passes through emissions control system 34 to reduce emissions that would otherwise exit to ambient through an exhaust outlet pipe 36.

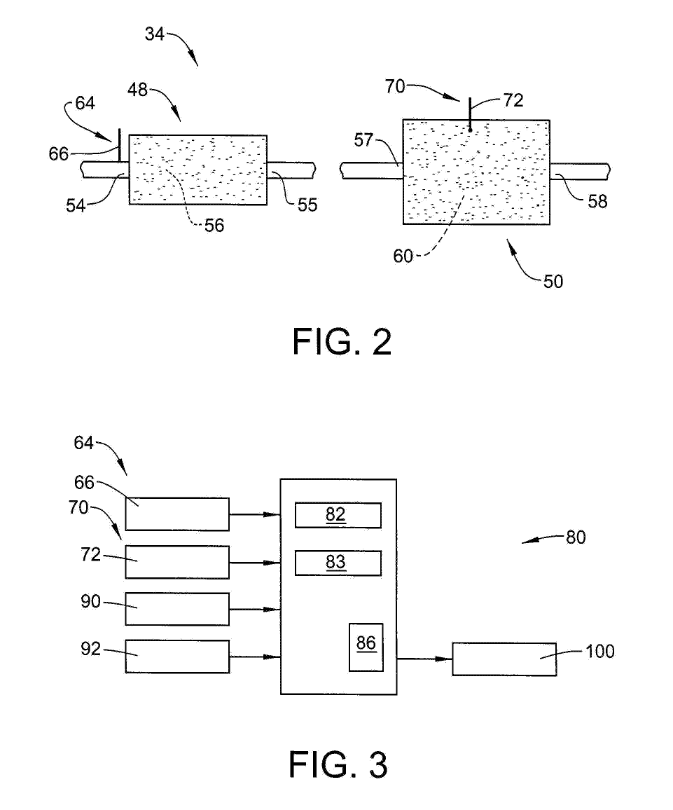

As shown in FIG. 2, emissions control system 34 includes a lean NOx trap (LNT) device 48 fluidically connected to a selective catalytic reduction (SCR) device 50. LNT device 48 includes an LNT inlet 54 fluidically connected to exhaust system 30 and an LNT outlet 55. LNT device 48 may include a LNT absorbent 56 selected to adsorb NOx molecules from exhaust gases produced by internal combustion engine system 24. SCR device 50 includes an SCR inlet 57 and an SCR outlet 58. SCR inlet 57 may be fluidically connected to LNT outlet 55. In this arrangement, SCR device 50 is positioned downstream of LNT device 48. SCR device 50 includes an SCR substrate 60 selected to remove various constituents, such as NH₃ from the exhaust gases produced by internal combustion engine system 24.

SCR device 50 is configured to reduce oxides of Nitrogen (“NOx”) in the exhaust gas. In various embodiments, SCR device 50 includes an SCR catalyst composition applied to substrate 60. SCR device 50 may utilize a reductant, such as ammonia (“NH₃”), to reduce the NOx. More specifically, the SCR catalyst composition may contain a zeolite and one or more base metal components such as iron (Fe), cobalt (Co), copper (Cu) or vanadium (V) which operate to convert NOx constituents in the exhaust gas in the presence of NH₃.

In accordance with an aspect of an exemplary embodiment, LNT device 48 includes at least one LNT sensor 64. LNT sensor 64 may take the form of a first temperature sensor 66 arranged at LNT inlet 54 to sense a temperature of exhaust gases entering LNT device 48. It is to be understood that the particular number, function, and location of LNT sensors may vary. SCR device 50 includes one or more SCR sensors 70. SCR sensor 70 may take the form of a second temperature sensor 72 arranged to detect a temperature of SCR substrate 60. It is to be understood that the particular number, function, and location of SCR sensors 70 may vary.

In further accordance with an exemplary aspect depicted in FIG. 3, emissions control system 34 is connected to an LNT regeneration control system 80 that is operable to selectively de-adsorb or de-NOx LNT device 48. LNT regeneration control system 80 may include a processor 82, a memory module 83, and an LNT regeneration controller 86. Memory module 83 may store one or more predetermined SCR temperature threshold values, and one or more predetermined LNT temperature threshold values that may be referenced to initiate regeneration of LNT device 48. Memory module 83 may also store one or more predetermined storage capacity threshold values for LNT device 48 as well as predetermined engine load threshold values and predetermined speed threshold values.

In the exemplary embodiment shown LNT regeneration control system 80 is connected to first temperature sensor 66 arranged at LNT inlet 54 and second temperature sensor 72 arranged at SCR substrate 60. Additionally, LNT regeneration control system 80 is electrically connected to an engine load sensor 90 that may sense torque on internal combustion engine system 24 and a speed sensor 92 that may detect the speed of diesel engine 26.

As will be detailed more fully below, based on inputs from first temperature sensor 66 and second temperature sensor 72 as well as data that may be received from engine load sensor 90 and speed sensor 92, LNT regeneration controller 86 selectively activates a regeneration system 100 that is operable to selectively de-adsorb or purge LNT device 48 of NOx molecules. Regeneration system 100 may take on a variety forms.

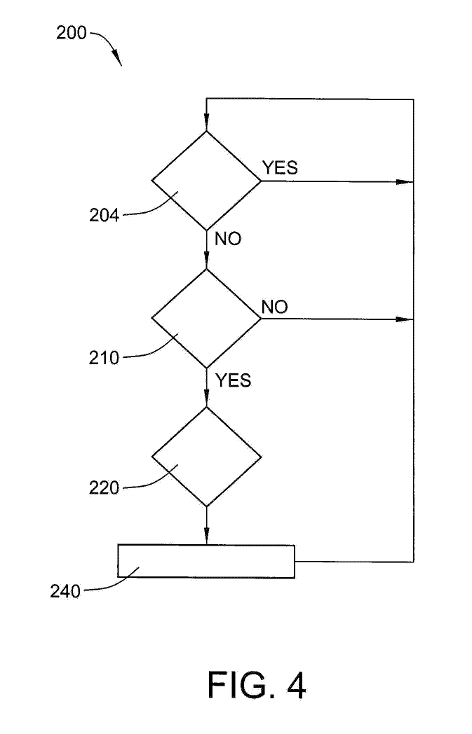

Referencing FIG. 4, a method of regenerating LNT device 48 is indicated generally at 200. LNT regeneration controller 86 receives a temperature input representing a temperature value in, for example, SCR substrate 60 from second temperature sensor 72 at block 204. If the temperature value received from second temperature sensor 72 is above a predetermined SCR temperature threshold value, no action is taken. However, if the temperature value from second temperature sensor 72 is below the SCR temperature threshold value, a determination is made, at block 210 whether exhaust gas temperature at LNT inlet 54 is above the predetermined LNT temperature threshold. Additionally, LNT regeneration controller 86 may determine whether LNT absorbent 56 includes a storage capability below a predetermined LNT storage threshold.

If the temperature at LNT inlet 54 is below the predetermined temperature threshold and/or the storage capability is above the predetermined storage threshold no action is taken and monitoring continues at block 204. If the temperature at LNT inlet 54 is below the predetermined temperature threshold and/or the storage capability is above the predetermined storage threshold, LNT regeneration controller 86 evaluates data from engine load sensor 90 and speed sensor 92 at block 220. If data from engine load sensor 90 and speed sensor 92 meets threshold criteria, LNT regeneration controller 86 activates regeneration system 100 to initiate a de-adsorption or NOx purge cycle for LNT device 48 at block 240.

It is to be understood that the exemplary embodiments describe a system for regenerating an LNT that is based not only on LNT parameters and engine parameters, but is also dependent upon SCR parameters. Further, LNT regeneration is targeted to periods when the SCR device is operating below threshold temperatures. Above the threshold temperature, the SCR device is operating at higher efficiency levels than when below the threshold temperature. Regeneration of the LNT creates heat that may be introduced into the SCR device to increase SCR substrate temperature above the threshold temperature. Thus, in accordance with the exemplary embodiment, regeneration of the LNT enhances operational efficacy of both the LNT and the SCR device in a single operation. Further, by tying LNT regeneration to SCR temperature, the number and of regeneration cycles may be reduced while at the same time enhancing regeneration efficiency.

The terms “about” and “substantially” are intended to include the degree of error associated with measurement of the particular quantity based upon the equipment available at the time of filing the application. For example, “about” can include a range of ±8% or 5%, or 2% of a given value.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An emissions control system for a motor vehicle including an internal combustion engine comprising:
a lean NOx trap (LNT) device including an LNT inlet and an LNT outlet;
a LNT sensor arranged at the LNT inlet; the LNT sensor being operable to detect a temperature of exhaust gases passing into the LNT device;
a selective catalytic reduction (SCR) device fluidically connected to the LNT device, the SCR device including an SCR inlet and an SCR outlet;
an SCR sensor mounted to the SCR, the SCR sensor being operable to detect a temperature of the SCR; and
a LNT regeneration control system including a LNT regeneration controller operatively connected to the LNT sensor and the SCR sensor, the LNT regeneration control system being operable to activate the LNT regeneration controller based on inputs from the LNT sensor and the SCR sensor.

2. The emissions control system according to claim 1, wherein the SCR includes an SCR substrate, the SCR sensor being operatively coupled to the SCR substrate.

3. The emissions control system according to claim 1, further comprising:
an engine load sensor operable to detect a load of the internal combustion engine; and
a speed sensor operable to detect a speed of the internal combustion engine, wherein the LNT regeneration control system is operable to activate the LNT regeneration control based on inputs from at least one of the engine load sensor and the speed sensor.

4. The emissions control system according to claim 1, wherein the LNT regeneration control system includes at least one memory module having stored thereon an SCR temperature threshold value, the LNT regeneration control system being operable to activate the LNT regeneration controller when the temperature of the SCR is below the SCR temperature threshold value.

5. The emissions control system according to claim 1, wherein the SCR inlet is fluidically connected to the LNT outlet.

6. A motor vehicle comprising:
an internal combustion engine including an exhaust system; and
an emissions control system fluidically connected to the exhaust system, the emissions control system comprising:
a lean NOx trap (LNT) device including an LNT inlet and an LNT outlet;
a LNT sensor arranged at the LNT inlet; the LNT sensor being operable to detect a temperature of exhaust gases passing into the LNT device;
a selective catalytic reduction (SCR) member fluidically connected to the LNT device, the SCR device including an SCR inlet and an SCR outlet;
an SCR sensor mounted to the SCR, the SCR sensor being operable to detect a temperature of the SCR; and
a LNT regeneration control system including a LNT regeneration controller operatively connected to the LNT sensor and the SCR sensor, the LNT regeneration control system being operable to activate the LNT regeneration controller based on inputs from the LNT sensor and the SCR sensor.

7. The motor vehicle according to claim 6, wherein the SCR includes an SCR substrate, the SCR sensor being operatively coupled to the SCR substrate.

8. The motor vehicle according to claim 6, further comprising:
an engine load sensor operable to detect a load of the internal combustion engine; and
a speed sensor operable to detect a speed of the internal combustion engine, wherein the LNT regeneration control system is operable to activate the LNT regeneration control based on inputs from at least one of the engine load sensor and the speed sensor.

9. The motor vehicle according to claim 6, wherein the LNT regeneration control system includes at least one memory module having stored thereon a SCR temperature threshold value, the LNT regeneration control system being operable to activate the LNT regeneration controller when the temperature of the SCR device is below the SCR temperature threshold value.

10. The motor vehicle according to claim 6, wherein the SCR inlet is fluidically connected to the LNT outlet.

11. A method of regenerating a lean NOx trap (LNT) device of an internal combustion engine in a motor vehicle comprising:
sensing a temperature of an SCR device fluidically connected to the LNT device;
sensing a temperature of the LNT device; and
activating a regeneration controller to de-adsorb NOx from the LNT based on the temperature of the SCR device and the temperature of the LNT device.

12. The method of claim 11, wherein sensing the temperature of the SCR device includes sensing the temperature of an SCR substrate of the SCR device.

13. The method of claim 11, wherein sensing the temperature of the LNT device includes sensing a temperature of an LNT inlet of the LNT device.

14. The method of claim 11, further comprising:
sensing a load on the internal combustion engine; and
sensing a speed of the internal combustion engine, wherein the regeneration controller is activated based on at least one of the load of the internal combustion engine and the speed of the internal combustion engine.

15. The method of claim 11, wherein the regeneration controller is activated when the temperature of the SCR device is below a predetermined temperature threshold.
